(19) United States
(12) Patent Application Publication
(10) Pub. No.: US 2026/0106933 A1
(43) Pub. Date: Apr. 16, 2026

(54) SYSTEM AND METHOD FOR CALL DIALING PROTECTION WITH CALLED PARTY AUTHENTICATION

(71) Applicant: Verizon Patent and Licensing Inc., Basking Ridge, NJ (US)

(72) Inventors: Brian Somes, Richardson, TX (US); Yi Jing, Belmont, MA (US); Charles David Briggs, Merritt Island, FL (US)

(21) Appl. No.: 18/916,830

(22) Filed: Oct. 16, 2024

(51) Int. Cl. H04M 1/72469; H04M 3/20; H04M 3/22; H04M 3/42; H04W 4/16; H04W 12/06

(52) U.S. Cl. CPC H04M 1/72469; H04M 3/20; H04M 3/2281; H04M 3/42093; H04W 4/16; H04W 12/06; H04M 2201/42

(57) ABSTRACT

One or more computing devices, systems, and/or methods for call dialing protection with called party authentication are provided. An application server receives a call initiation request to establish a communication call session between user equipment and a recipient number. Information associated with the recipient number is identified. The information indicates whether the recipient number is a known suspicious actor or not. The information and an option to proceed or cancel with establishing the communication call session to call the recipient number is provided through the user equipment before establishing the communication call session.

### BACKGROUND

Many service providers, such as cellular service providers of a wireless communication network, provide inbound caller identification. When a user receives a phone call on user equipment from a calling party, the phone number of the calling party may be displayed on the user equipment. Additional information may also be displayed such as a name of the calling party and/or a notification that the calling party may be potential spam. In this way, the user can utilize the information to determine whether to answer the incoming phone call or not.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for call dialing protection with called party authentication, in accordance with an embodiment of the present technology;

FIG. 2 is a flow chart illustrating an example method for call dialing protection with called party authentication, in accordance with an embodiment of the present technology;

FIG. 3A illustrates an example of a system for call dialing protection with called party authentication where a communication call session is established, in accordance with an embodiment of the present technology;

FIG. 3B illustrates an example of a system for call dialing protection with called party authentication where a communication call session is terminated, in accordance with an embodiment of the present technology;

FIG. 4 illustrates an example of a system for call dialing protection with called party authentication where feedback is received from a user, in accordance with an embodiment of the present technology;

FIG. 5A illustrates an example of a system for call dialing protection with called party authentication where information is provided through a dialer app, in accordance with an embodiment of the present technology;

FIG. 5B illustrates an example of a system for call dialing protection with called party authentication where information is provided through a dialer app, in accordance with an embodiment of the present technology;

FIG. 5C illustrates an example of a system for call dialing protection with called party authentication where artificial intelligence (AI) functionality is provided, in accordance with an embodiment of the present technology;

FIG. 5D illustrates an example of a system for call dialing protection with called party authentication where a live specialist is connected to a phone call, in accordance with an embodiment of the present technology;

FIG. 5E illustrates an example of a system for call dialing protection with called party authentication where a call recording option is provided for a phone call, in accordance with an embodiment of the present technology;

FIG. 5F illustrates an example of a system for call dialing protection with called party authentication where feedback is received from a user, in accordance with an embodiment of the present technology;

FIG. 5G illustrates an example of a system for call dialing protection with called party authentication where a call is automatically connected, in accordance with an embodiment of the present technology;

FIG. 5H illustrates an example of a system for call dialing protection with called party authentication where called party identity verification results are provided, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for call dialing protection with called party authentication. Unlike conventional inbound caller identification services that provide information to a call recipient about a calling party of an incoming call, the disclosed techniques provide a caller (calling party) with information about a number that the caller is attempting to dial through an outbound call. For example, a user may connect to a service provider such as a cellular service provider using a mobile device. The user may register for call dialing protection, or call dialing protection may be automatically provided for the user. When the user attempts to use a dialer app of the mobile device such as a phone app to place a call to a recipient number (a dialed phone number), the service provider may utilize an application server to provide the call dialing protection for the call. In particular, the application server may query one or more data sources with the recipient number in order to obtain information related to the recipient number such as whether the recipient number is a known suspicious actor (e.g., a spam entity attempting sell something to the user, a bad actor trying to defraud the user, etc.). In this way, the application server may provide the information to the user before the call is connected, such as by playing an audio message or displaying text or a graphic about whether the recipient number could be a suspicious actor. Thus, the user can request to proceed with the call or terminate the call.

Other features may be provided to the user during the call. In some embodiments, called party identification verification is provided as part of establishing the call (e.g., after the user decides to proceed with the call, but before the user is connected to a dialed party of the recipient number). If the user proceeds with the outbound call to the recipient number, then a called party identification verification service is triggered to authenticate the recipient number. A result of the verification is provided back to the user during the call. In some embodiments, additional in-call support is provided during the call, such as where the user can record the call, an in-person specialist (e.g., a fraud prevention specialist) can be connected to the call, an artificial intelligence (AI) assistant can be connect to the call, the user can submit feedback or details about how the call is going or went, the user can report a bad actor or suspected fraud used as feedback, etc. In this way, enhanced security is provided for users that may be inadvertently calling a suspicious actor (e.g., calling back a missed call from a spam caller, calling a number from a spam email, a misdial, etc.).

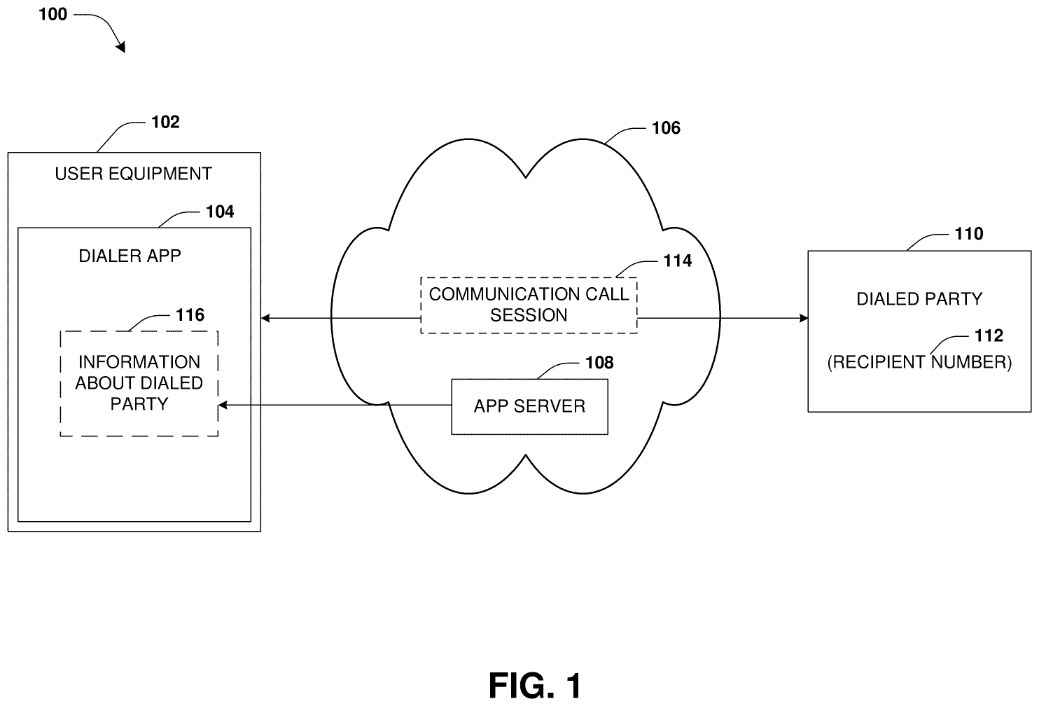

FIG. 1 illustrates an example of a system 100 for call dialing protection with called party authentication. A user may connect user equipment 102 to a communication network 106, such as a mobile device to a cellular communication network. The user may register with a service provider of the communication network 106 to enable call dialing protection. The user equipment 102 may execute a dialer app 104, such as a phone app through which the user can call phone numbers. The user may input a number into the dialer app 104, which is referred to as a recipient number 112 of a dialed party 110. The input of the recipient number 112 is used to generate a call initiation request to establish a communication call session 114 between the dialer app 104 and the dialed party 110. In response to the call initiation request being generated, the dialer app 104, such as through a dialer app extension, is connected with an application server 108 configured to implement the call dialing protection for the user.

The application server 108 may query various data sources to identify information 116 related to the recipient number 112. The information 116 may indicate that the recipient number 112 is associated with a known business, an individual with normal non-spam calling/texting behavior, a known suspicious actor such as a potential spam phone number, etc. The application server 108 may provide the information 116 to the user, such as through an audible message, text displayed through the dialer app 104, a graphic, etc. In some embodiments, the information 116 is provided with an option for the user to either continue with establishing the communication call session 114 or to cancel/terminate the establishment of the communication call session 114. The information and/or option may be provided before the communication call session 114 has been enabled (e.g., before the dialer app 104 has been communicatively coupled through the communication network 106 with the dialed party 110; before the recipient number 112 is rung; etc.).

The application server 108 or other network equipment or service within the communication network 106 may provide additional functionality such as called party identification verification during the establishment of the communication call session 114. The called party identification verification may be performed by an originating service provider of the user equipment (the service provider with which the user is registered for call dialing protection), a terminating service provider of the dialed party 110, a verification service used by the originating service provider utilizing a public key, and/or an authentication service used by the terminating service provider utilizing a private key. A result of the called party identification verification may be provided to the user such as during the establishment of the communication call session 114 after the user has selected the option to continue with establishing the communication call session 114.

The application server 108 or other network equipment or service within the communication network 106 may provide in-call support during the call. The in-call support may include features where the user can record the call, an in-person specialist (e.g., a fraud prevention specialist) can be connected to the call, an AI assistant can be connect to the call, the user can submit feedback or details about how the call is going or went, report a bad actor or suspected fraud, etc.

In this way, the user is provided with enhanced security and support before dialing a number, during establishment of a communication call session with a dialed party, and/or during a call between the user and the dialed party.

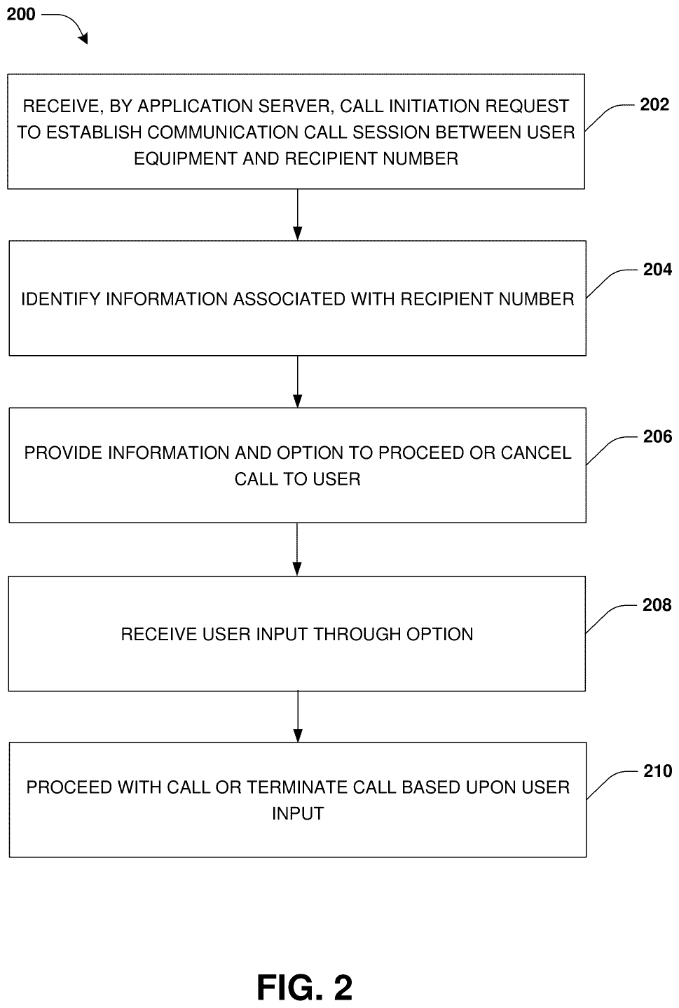

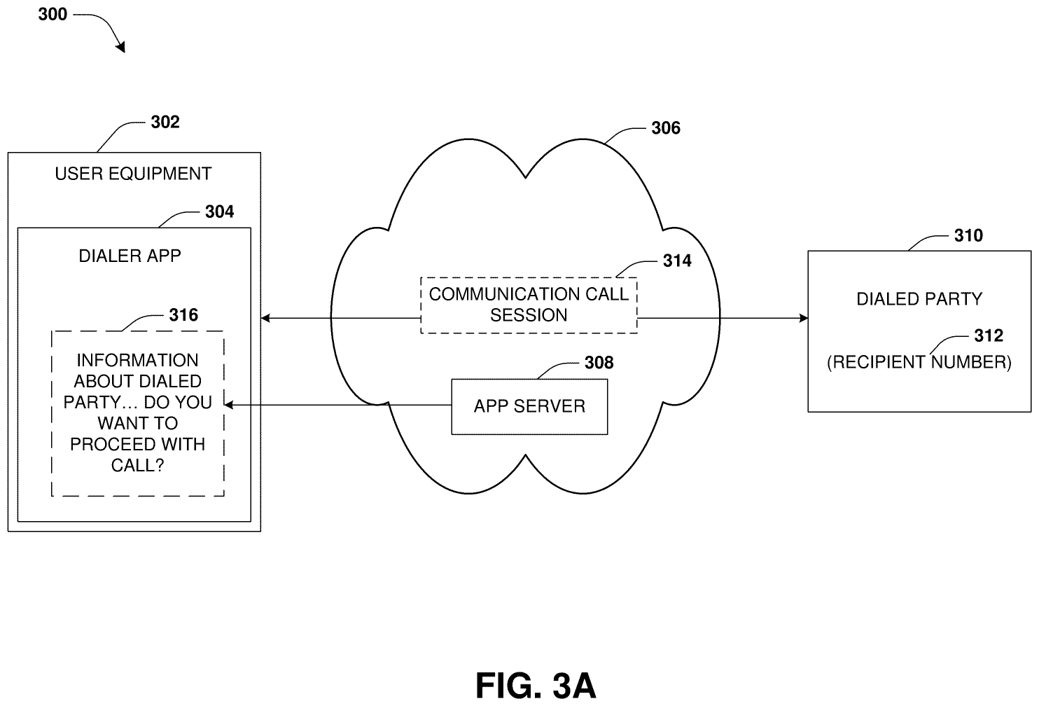

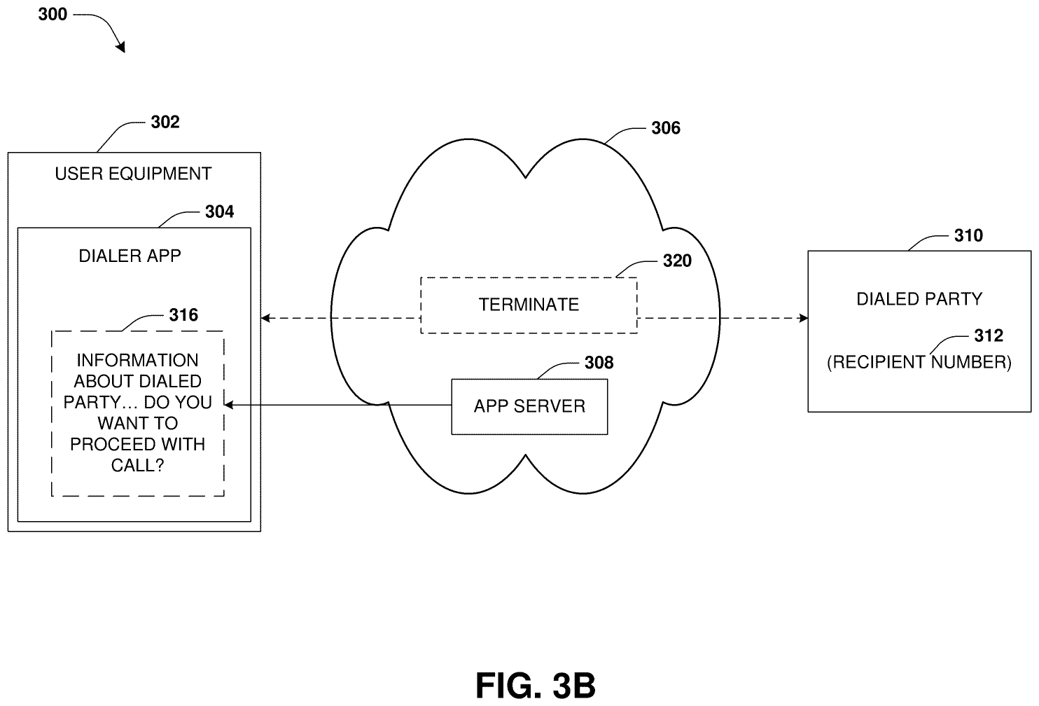

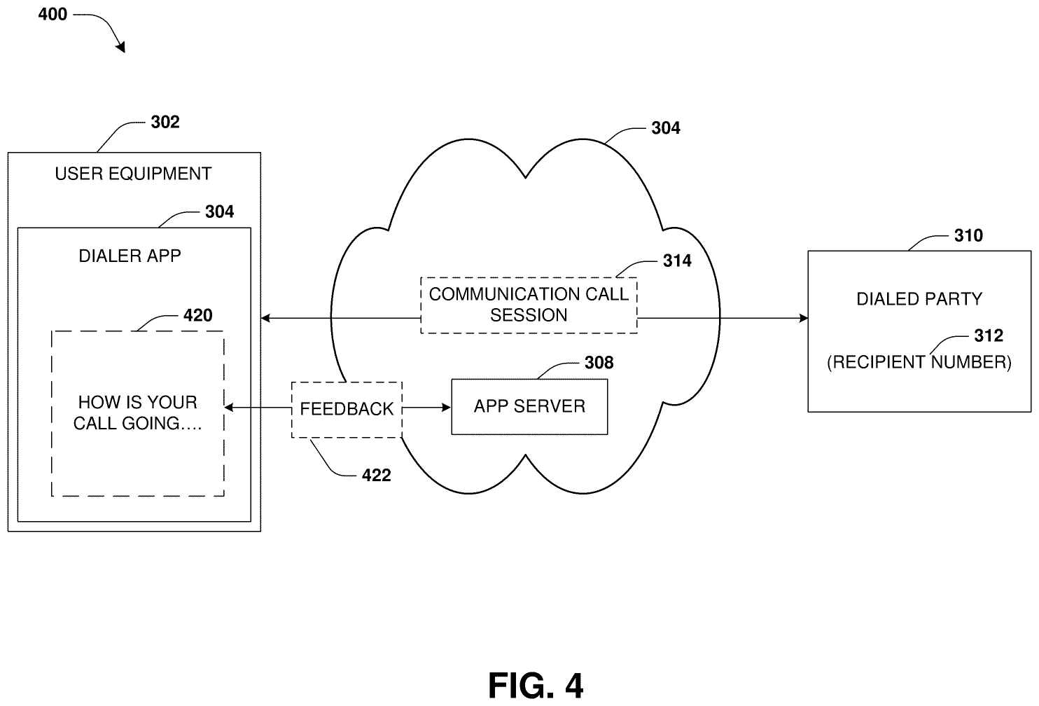

FIG. 2 is a flow chart illustrating an example method 200 for call dialing protection with called party authentication, which is further described in conjunction with system 300 of FIGS. 3A and 3B and system 400 of FIG. 4. The method 200 is provided such that a calling party of an outbound call is provided with real-time information to help protect the calling party from accidentally, knowingly, or being coerced into completing a call to a bad actor, potentially dangerous/costly number, unknowingly participating in a denial-of-service (DoS) attack, etc., and thus the calling party is provided with a dialing double-check before the call is progressed/originated. If the calling party decides to continue with the call, network authentication of the recipient number is provided back to the calling party as an additional confirmation (e.g., called party identification verification after the call is routed to the dialed party being dialed by the calling party). Call dialing protection provides an additional level of security on outbound calls, which could also be used to protect users that may be susceptible to accidental or coerced misdials. Additionally, live in-call support may be provided in real-time during the live call between the calling party and dialed party. Furthermore, the calling party may provide a report about the call and/or feedback data may be automatically collected and used to further train/enhance fraud protection and bad actor detection services.

In some embodiments, a user of user equipment 302 may sign up with a service provider of a communication network 306 for call dialing protection to be performed prior to actually launching and routing calls to dialed parties. As part of signing up with the service provider, the user equipment 302 (e.g., a user device, dialer, client, etc.) may be provisioned with a dialer app extension for a dialer app 304 (e.g., provisioning via a home subscriber server), and thus the communication network 306 such an as an IP multimedia subsystem (IMS) Core/call session control function (CSCF) would recognize a calling number of the user as being activated for call dialing protection.

The user may utilize the dialer app 304 on the user equipment 302 to dial a number for placing a call to the number, which is referred to as the recipient number 312 of the dialed party 310, as illustrated by FIG. 3A. During operation 202 of method 200, the application server 308 within the communication network 306 receives a call initiation request from the user equipment 302 to establish a communication call session 314 between the dialer app 304 and the dialed party 310 associated with the recipient number 312. In some embodiments, if the recipient number 312 is within a contact list of the user of the user equipment 302, is called above a threshold frequency (e.g., called more than twice a month), or is specified as a designated opt-out number (e.g., a known emergency number, a number with which the user has specified as being a designated opt-out number, etc.), then the communication call session 314 is established as normal and call dialing protection processing by the application server 308 is bypassed.

During operation 204 of method 200, the application server 308 identifies information associated with the recipient number 312. The information may be extracted from various data sources such as a caller ID name (CNAM) data source, a reverse-lookup data source, a local exchange routing guide (LERG) data source, a known validity/risk profile data source, etc. The information may indicate whether the recipient number 312 is a known suspicious actor, a known safe number, an unknown number, or any other information about the dialed party 310 such as a name of the dialed party 310, whether users have reported the dialed party 310 as spam or a scam, etc. In some embodiments, the user may terminate the call dialing protection processing at any time, such as where the user invokes a user interface element such as a “skip” or “dial now” element that generates a break-in indicator causing a user break-in operation to terminate call dialing protection and dial the recipient number 312. In order to support the user break-in operation, the application server 308 may provide an early media implementation to receive user input of the break-in indicator (e.g., a DTMF key press input or the dialer app 304 returning a break-in indicator over an HTTP connection).

In some embodiments, an amount and type of detail to provide the user as the information may be based upon a setting, such as where the user requests to receive audio prompts, text prompts, image prompts, a length or time duration of a prompt, certain types of details to provide (e.g., display a name of the dialed party 310, display user feedback by other users for the dialed party 310, etc.), and/or any other information. In some embodiments, a threat level associated with the dialed party 310 may be identified (e.g., the dialed party 310 may have been reported as a scammer attempting to defraud callers of money as a high threat, compared to a lower threat of a dialed party trying to sell legitimate products or services). In some embodiments, a service may determine the threat level, and thus the application server 308 may query the service or a database of the service to retrieve the threat level assigned by the service to the dialed part 310 (e.g., query a blocked number list, a reverse look-up and caller names database, a STIR/SHAKEN service, a list of reported/verified/flagged numbers, etc.). A suggestion for how to proceed with the call may be selected based upon the threat level (e.g., “proceed with caution” for a medium threat, “be careful giving payment information to called party” as a medium threat, “suggestion that you hang up now and/or press the report option on app” for a higher threat, “stay on the line and you will be connected” for a lower or no threat, “hang-up” for a higher threat, etc.). In this way, the suggestion may be included within the information to provide to the user.

During operation 206 of method 200, the information is provided through the user equipment 302 before the communication call session 314 has been established to place the call with the recipient number 312. The information may be displayed through a user interface 316 of the dialer app 304, played through a speaker of the user equipment 302, etc. In some embodiments, an option may be provided to the user for selecting whether to proceed with the call or to terminate/cancel the call. During operation 208 of method 200, user input is received through the option. If the user input requests to proceed with the call, then the communication call session 314 is established to connect the user with the dialed party 310, as illustrated by FIG. 3A. If the user input requests to cancel the call, then the communication call session 314 is terminated 320, as illustrated by FIG. 3B. In this way, the call is either proceeded with or terminated, during operation 210 of method 200.

In some embodiments, the application server 308 does not answer the call being placed through the dialer app 304, but establishes a temporary early media path between the user equipment 302 and the application server 308 (e.g., by returning a 183, such as an SIP construct of P-Early-Media session establishment prior to a call being answered by 130 for two-way audio). The temporary early media path may be used to present the information in text or graphical form, such as via HTTP through the dialer app 304 using an extension (a pop-up extension) in the dialer app 304. In some embodiments, the information is played as an audio message with additional information about the recipient number 312. In some embodiments, a data only implementation is facilitated to convey the information without establishing an audio path or utilizing application server media capabilities. The application server 308 may return a message (e.g., a 100 Trying message) and one or more empty messages (e.g., 183 Progress message) to maintain a SIP signaling connection active while the information is provided over HTTP to the user through the user equipment 302.

In some embodiments, the application server 308 maintains an invite (e.g. a SIP INVITE) transaction until the user indicates to proceed with the call or a timeout for response has occurred that causes termination of the call. In response to receiving the indication to proceed, the invite transaction is used for routing to the recipient number 312.

If the user selects to not complete the call, then the attempt to establish the communication call session 314 is ended (e.g., a SIP cancelled message is generated or the application server 308 provides a SIP error response to the CSCF to abandon the call attempt).

In some embodiments, the information is played as a voice message such as: “This is the number you dialed [ . . . ],” “To immediately place call press the [#] button . . . otherwise please review the following information before proceeding,” “This number is in your contact list with assigned name [name]/you have called this number before,” “This number belongs to name [called name] if available or [/not available/unknown] etc. ,” “This is an international number for country [country . . . /non-US WZ1 country/territory/ . . . etc.],” “Warning—this is a high cost number to dial and you will be charged the rate of this number if you continue . . . ,” “Warning/Caution this is a known [suspect/fraudulent/unverified/no information/etc.] call back number,” “The owner of this [Toll Free] number [“Bank ABCD” etc.] has requested that you please verify that you intended to call [“Bank ABCD” etc.].”

In some embodiment, a pop-up with the information, the option, and a countdown for when the call will automatically proceed after a timeout may be displayed.

In some embodiments, the user is provided with an interface 420 (a feedback reporting user interface) through which the user can submit a report such as feedback 422 related to the call with the dialed party 310, as illustrated by FIG. 4. The feedback 422 may specify whether the user feels that the dialed party 310 is suspicious, safe, threatening, spam, sales, etc., how/why the user come to dial the recipient number 312, and/or other information. The application server 308 may utilize the feedback 422 to update call information used by the application server 308 to identify suspicious actors and numbers. The feedback 422 and/or updated call information may be used to help identify suspicious actors that are providing the bad call back numbers. This can be accomplished through HTTPs connections from user equipment to the application server 308, or via SIP signaling with the application server 308 where the application server 308 can send a SIP out-of-dialog message with XML or JSON content container with a user's spam report or description. The spam report or description can be subsequently provided to a calling party as information about a call being placed to a recipient number. In some embodiments, a report may be received as a SIP spam report coded message. The feedback 422 may also be provided to data sources used by the application server 308 for identifying the information associated with the recipient number 312, which can also be used for investigations of abuse.

In some embodiments, the user may have registered for called party identification verification. Once the user provides an indication to proceed with the call to the recipient number 312, the called party identification verification may be implemented as part of establishing the communication call session 314. An originating service provider may be invoked to verify an identity of the dialed party 310 (recipient number 312). The identity may be provided to the user, such as through a message indicating that the dialed party 310 was successfully verified. The identity of the dialed party 310 may be provided as part of connecting the dialer app 304 to the recipient number 312, but before the user has been connected to and is able to communicate with the dialed party 310.

In some embodiments, the originating service provider is configured with a feature-capability indicator within a header field in an invite (e.g. a SIP INVITE message). The feature-capability indicator is used to indicate that the originating service provider has a capability of performing called party identification verification. In some embodiments, the identity information for the dialed party 310 is cryptographically signed with a user name, a company name, and/or a service type. The identity information is used by a terminating service provider to which the dialed party 310 is connected to verify the identity of the recipient number 312/dialed party 310 with the originating service provider.

In some embodiments of implementing the called party identification (CPI) verification, the call is sent to trigger a called party identification verification service. The user receives a verified CPI as the call is ringing and/or being connected to the dialed party 310 if the terminating service provider (TPS) serving the dialed party 310 supports CPI authentication. The user may be provisioned via a home subscriber server (HHS) and with a dialer app extension so that an IMS Core/CSCF would know that this calling number has registered for and activated the called party identification service. The original service provider (OSP) includes a feature-capability indicator within a header field in the invite to indicate that the OSP has the capability to verify CPI. If the TSP supports CPI authentication, then the TSP can cryptographically sign the CPI information (e.g. a person's name, a company name, a service type, etc.) leveraging a STIR framework with a new PASSporT extension (e.g. ppt=cpi) or reuse a rich call data (RCD) extension, and inserts a SIP identity header within signaling in a reverse direction of the invite (e.g., through provisioning, an OK response, or a new request such as an update or re-invite). The CPI information is verified/vetted by the TSP (e.g., TSP subscriber account information verification) or through another trustable vetting process. The TSP conducts the authentication process if the feature-capability indicator is in the invite. Upon receiving the identity header containing the CPI information, the OSP conducts the verification process. If successful, then the identity (verification information) is provided to the user/call through either SIP signaling or through an out of band mechanism.

In some embodiments, the user may register for in-call support that may be provided as the user communicates with the dialed party 310 over the communication call session 314. In some embodiments, the in-call support may include a call recording option that may be invoked by the user for the call to be recorded between the user and the dialed party 310. In some embodiments, the in-call support may include a live support option that may be invoked by the user to merge a call support user into the call between the user and the dialed party 310 (e.g., merge a fraud specialist into the call). In some embodiments, the in-call support may include an artificial intelligence (AI) option that may be invoked by the user so that AI support is provided for the call between the user and the dialed party 310 (e.g., a chat bot that can respond to questions, input queries, provide advice based upon the conversation content, etc.). In some embodiments, the in-call support may include a feedback reporting option that may be invoked by the user to submit feedback/report through a feedback reporting user interface regarding the call (e.g., the user can specify how/why the user dialed the number, how the user felt about the call or dialed party 310, whether the user felt the dialed party 310 may a spam, a scam, unsolicited sales, threatening, etc.). The feedback/report may be used to update call information utilized by the application server 308 for identifying information about the recipient number 312/dialed party 310.

In some embodiments, the in-call support may be provided by the application server 308 implementing an early media option with a media path to the user equipment 302, where the application server 308 stays in the media path when the dialed party 310 answers the call. The HTTPs connection between the application server 308 and the dialer app 304 is retained to collect in-call instructions from the user and to provide back real-time analysis and functionality (e.g., AI generated suggestions).

In some embodiments, call dialing protection is provided for Over-the-Top (OTT) calls, such as Voice over Internet Protocol (VoIP) calls, from client apps. In some embodiments, call dialing protection can be implemented when client communication apps (e.g., voice anywhere, voice/phone client apps, etc.) use web clients for calls and/or for any other type of voice calling services. Call dialing protection may be implemented within the communication network for web-based calls from web-based clients whose calls are driven through the app server 308.

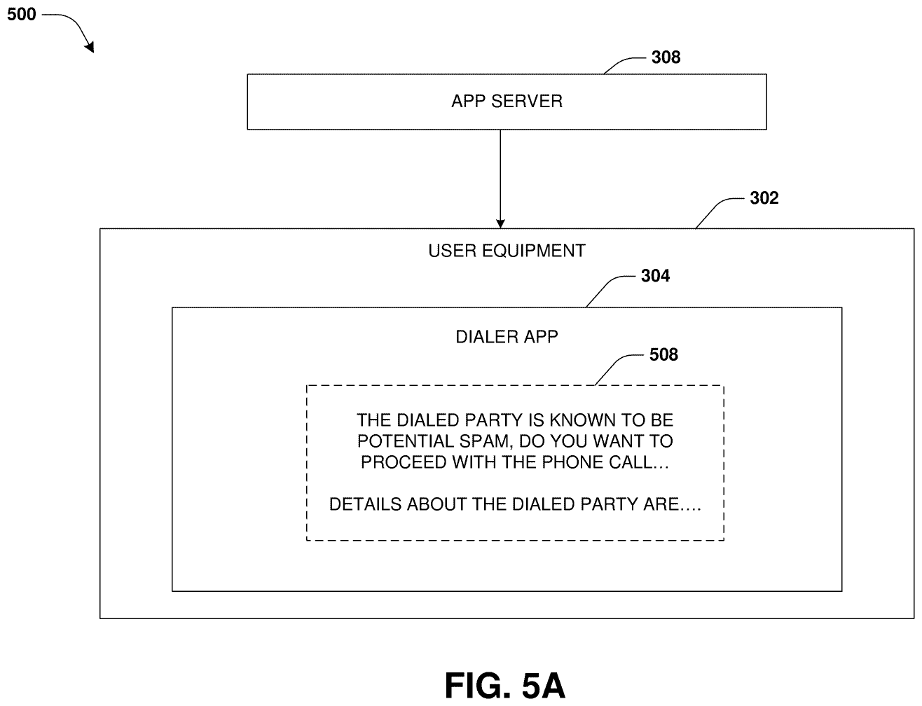

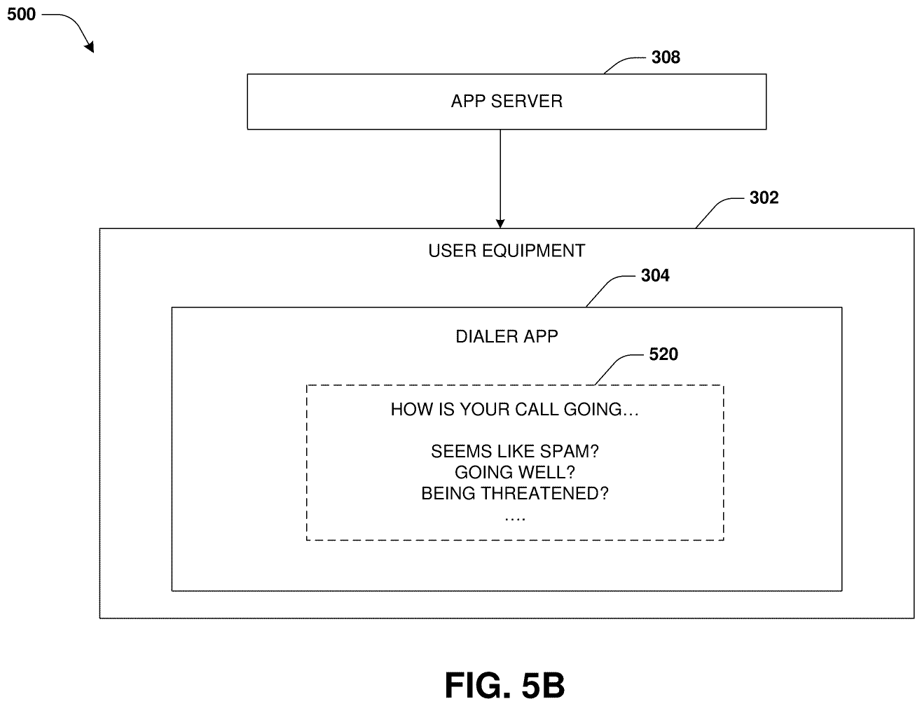

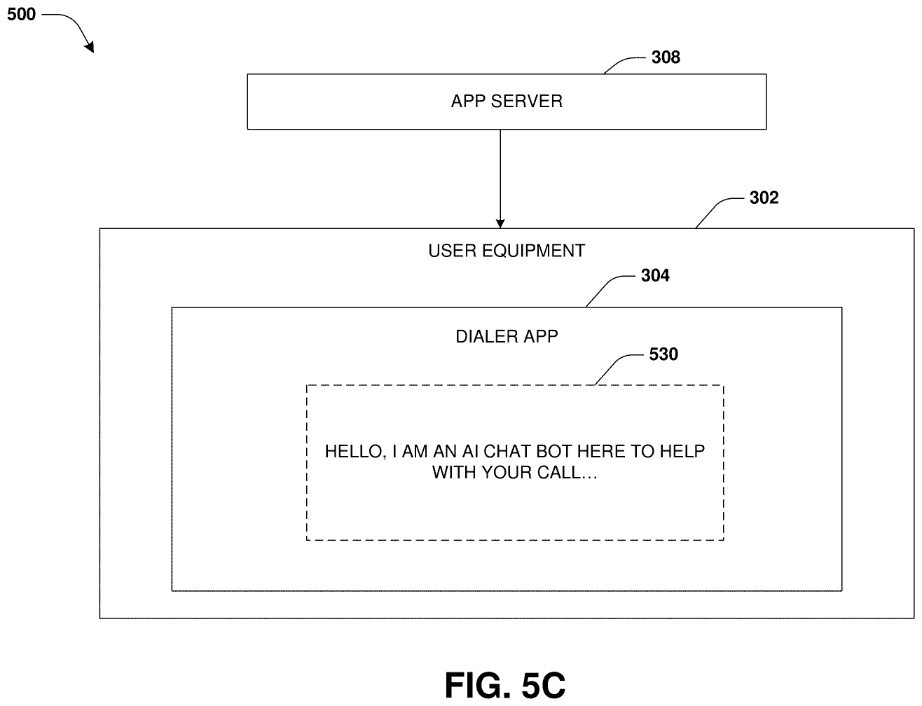

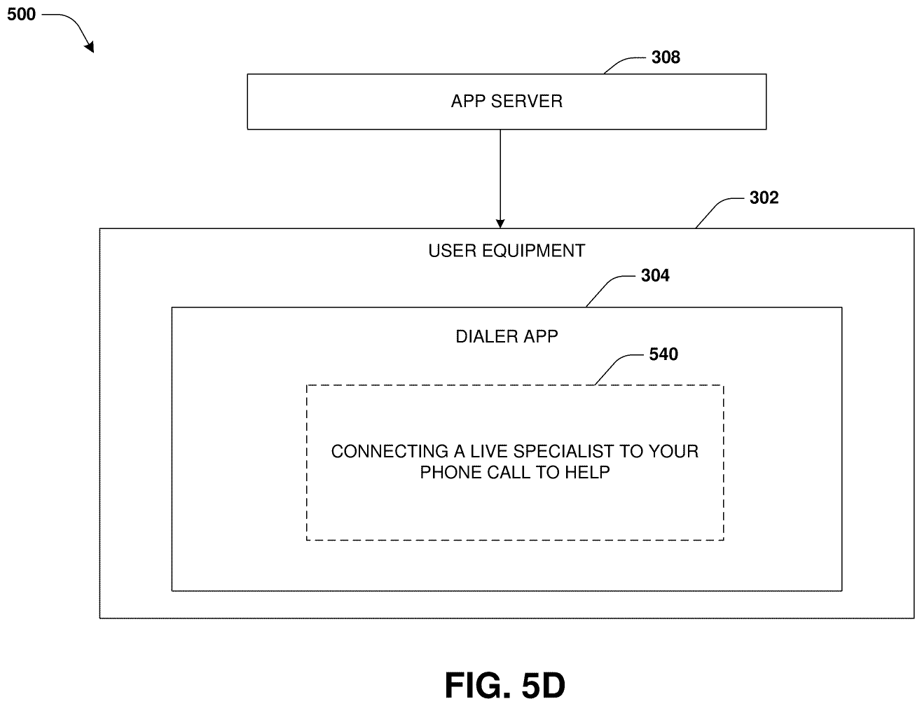

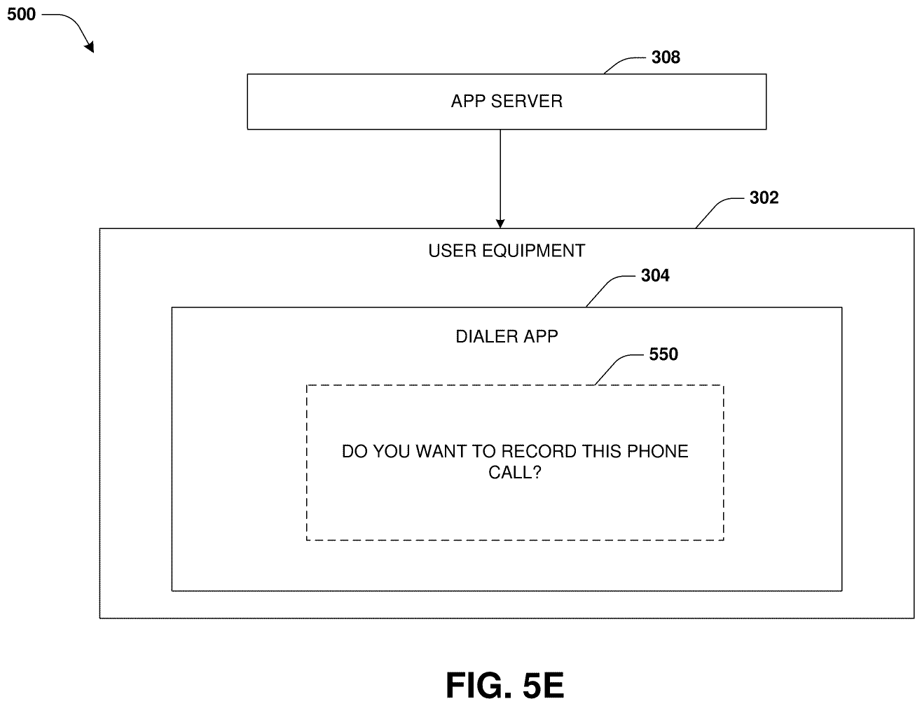

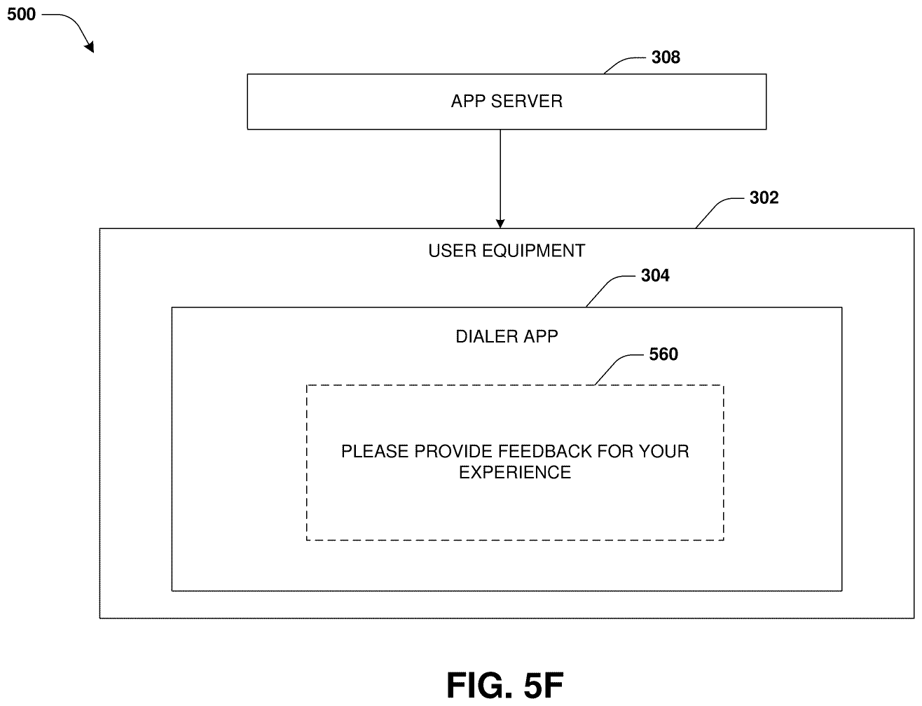

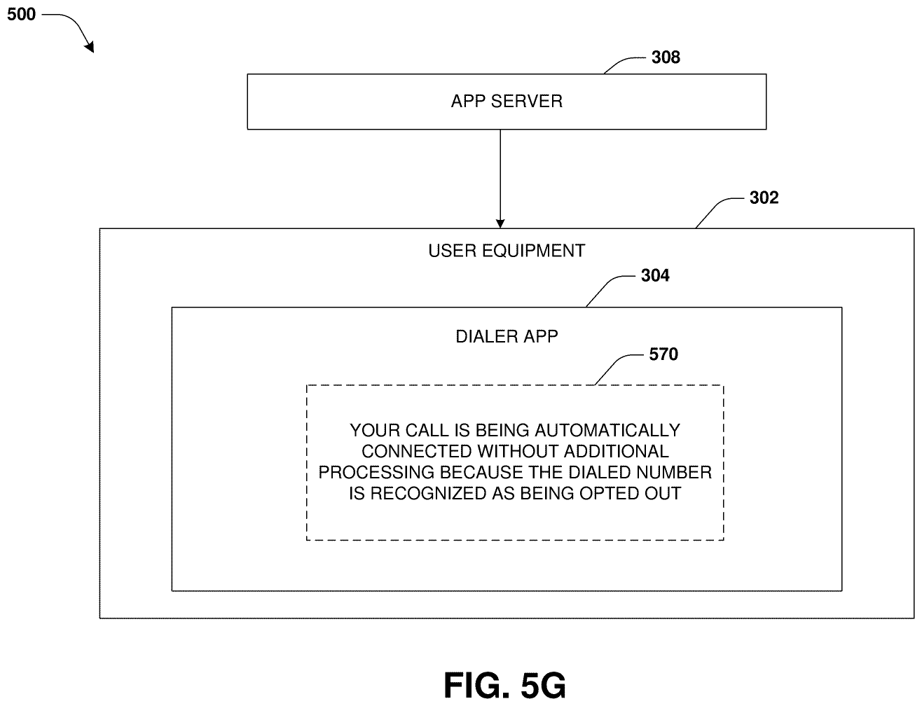

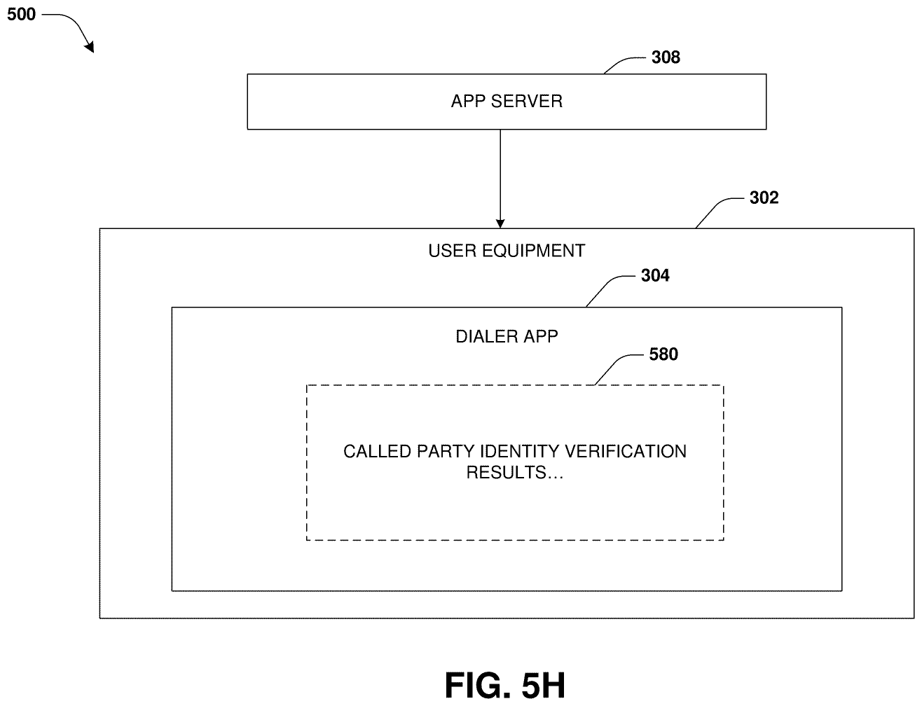

FIGS. 5A-5H illustrate an example of a system 500 for call dialing protection. A user may utilize the dialer app 304 to establish a communication call session between the user equipment 302 and a recipient number of a dialed party. Before the communication session is established, the application server 308 identifies information 508 associated with the recipient number. The application server 308 provides the information 508 through the user equipment 302, such as a through a user interface within the dialer app 304, as illustrated by FIG. 5A. The information 508 may state “The dialed party is known to be potential spam, do you want to proceed with the phone call . . . details about the dialed party are . . . ”

The application server 308 may provide in-call support, such as where the user is provided with a report feedback reporting user interface 520 through which the user may provide feedback, as illustrated by FIG. 5B.

The application server 308 may provide in-call support, such as where the user is provided with an interactive AI assistant 530 (e.g., an AI chat bot or other AI support) that aids the user during the call, as illustrated by FIG. 5C. The interactive AI assistant 530 may ask the user questions, response to queries and questions received from the user, provide the user with advice determined by the interactive AI assistant 530 using various AI/ML models based upon the conversation, etc. This may be accomplished through an option on the dialer app with a trigger to the application server via HTTPs connection or via a DTMF keypress code over an audio path. Real-time information from the interactive AI interactive AI assistant 530 530 may be provided from the application server to the user via the HTTPs connection to the dialer app.

The application server 308 may provide in-call support, such as where the user utilizes a live support option 540 to be connected to a live specialist to help with the call, as illustrated by FIG. 5D. This may be accomplished through an option on the dialer app with a trigger to the application server via HTTPs connection or via a DTMF keypress code over an audio path. The live specialist may be merged into the call through an n-way call procedure.

The application server 308 may provide in-call support, such as where the user utilizes a call recording option 550 to record the call, as illustrated by FIG. 5E. In some embodiments, a live announcement that the call is being recorded may be made by the application server. This may be accomplished through an option on the dialer app with a trigger to the application server via HTTPs connection or via a DTMF keypress code over an audio path. If the user submitted a report, then the audio recording could be linked to by the report for further review or action.

In some embodiments, the user may be provided with an interface 560 through which the user can submit feedback or a report about the user's call experience, as illustrated by FIG. 5F.

In some embodiments, the user may be provided with a notification 570 that the call is being automatically connected without additional processing because the dialed number is recognized as being an opted out number, as illustrated by FIG. 5G.

In some embodiments, the user may be provided with called party identification verification results 580 associated with the called party/recipient number being verified, as illustrated by FIG. 5H.

According to some embodiments, a method is provided. The method includes receiving, by an application server of a communication network from a dialer app of user equipment, a call initiation request to establish a communication call session between the user equipment and a recipient number; identifying information associated with the recipient number, wherein the information indicates whether the recipient number is a known suspicious actor or not; and providing, through the user equipment before establishing the communication call session, the information and an option to proceed or cancel with establishing the communication call session to call the recipient number.

According to some embodiments, the method includes creating, by the application server, a temporary early media path between the user equipment and the application server to establish two-way audio without the application server answering the call; and playing an audio message with the information utilizing the temporary early media path.

According to some embodiments, the method includes displaying the information through at least one of text or a graphic displayed through an extension in the dialer app.

According to some embodiments, the method includes maintaining, by the application server, an invite transaction until an indication is received from a user to proceed with the call or a timeout has occurred; and in response to receiving the indication, utilizing the invite transaction for routing to the recipient number.

According to some embodiments, the method includes selecting an amount and type of detail to provide as the information based upon a setting.

According to some embodiments, the method includes in response to detecting a threat level associated with the recipient number, selecting a suggestion for how to proceed with the call; and including the suggestion within the information provided to a user, wherein the suggestion is provided to the user before the communication call session is established.

According to some embodiments, the method includes in response to receiving a break-in indicator from the dialer app, implementing a user break-in operation to dial the recipient number.

According to some embodiments, the method includes instructing the user equipment to display an interface through which a user can submit a report related to the recipient number; and in response to receiving the report, updating call information accessible to the application server based upon the report.

According to some embodiments, the method includes in response to detecting that the recipient number is within a contact list, is a number called above a threshold frequency, or is a designated opt-out number, bypassing the application server processing the recipient number.

According to some embodiments, a system comprising one or more processors configured for executing the instructions to perform operations, is provided. The operations include receiving, by an application server of a communication network from a dialer app of user equipment, a call initiation request to establish a communication call session between the user equipment and a recipient number; identifying information associated with the recipient number, wherein the information indicates whether the recipient number is a known suspicious actor or not; and providing, through the user equipment before establishing the communication call session, the information and an option to proceed or cancel with establishing the communication call session to call the recipient number.

According to some embodiments, the operations include registering a user of the user equipment for called party identification verification; in response to the user being registered for the called party identification verification, invoking an originating service provider to verify an identity of the recipient number; and providing the identity to the user.

According to some embodiments, the operations include providing the identity to the user as part of connecting the dialer app to the recipient number.

According to some embodiments, the operations include configuring the originating service provider with a feature-capability indicator within a header field in an invite to indicate that the originating service provider has a capability of performing called party identification verification.

According to some embodiments, identity information for the recipient number is cryptographically signed with at least one of a user name, a company name, or a service type, wherein the identity information is used by a terminating service provider to verify the identity of the recipient number with the originating service provider.

According to some embodiments, a non-transitory computer-readable medium storing instructions that when executed facilitate performance of operations, is provided. The operations include receiving, by an application server of a communication network from a dialer app of user equipment, a call initiation request to establish a communication call session between the user equipment and a recipient number; identifying information associated with the recipient number, wherein the information indicates whether the recipient number is a known suspicious actor or not; and providing, through the user equipment before establishing the communication call session, the information and an option to proceed or cancel with establishing the communication call session to call the recipient number.

According to some embodiments, the operations include in response to a user being registered for in-call support, providing a call recording option for calling the recipient number; and in response to receiving user input for the call recording option, recording the call between the user and the recipient number.

According to some embodiments, the operations include in response to a user being registered for in-call support, providing a live support option for calling the recipient number; and in response to receiving user input for the live support option, merging a call support user into the call between the user and the recipient number.

According to some embodiments, the operations include in response to a user being registered for in-call support, providing an artificial intelligence support option for calling the recipient number; and in response to receiving user input for the artificial intelligence support option, providing the user with artificial intelligence support during the call between the user and the recipient number.

According to some embodiments, the operations include in response to a user being registered for in-call support, providing a feedback reporting option for calling the recipient number; and in response to receiving user input for the feedback reporting option, providing the user with a feedback reporting user interface through which to report feedback regarding the call.

According to some embodiments, the operations include in response to a user being registered for in-call support, providing a feedback reporting option for calling the recipient number; and in response to receiving a report through the feedback reporting option, updating call information accessible to the application server based upon the report.

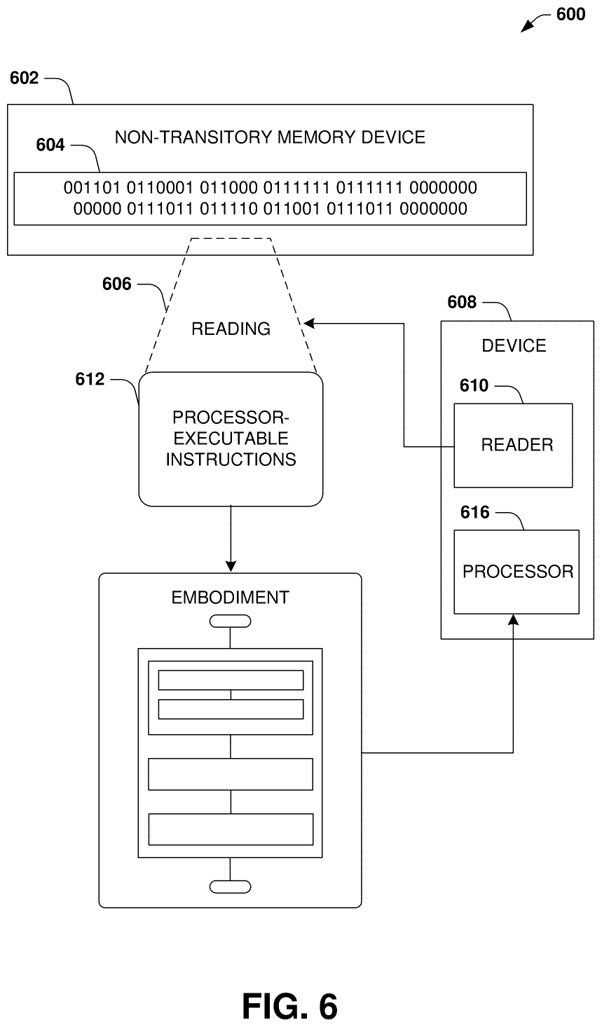

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2, for example. In some embodiments, the processor-executable instructions 612 are configured to cause implementation of a system, such as at least some of the example system 100 of FIG. 1, at least some of example system 300 of FIGS. 3A and 3B, and/or at least some of the example system 400 of FIG. 4, etc.

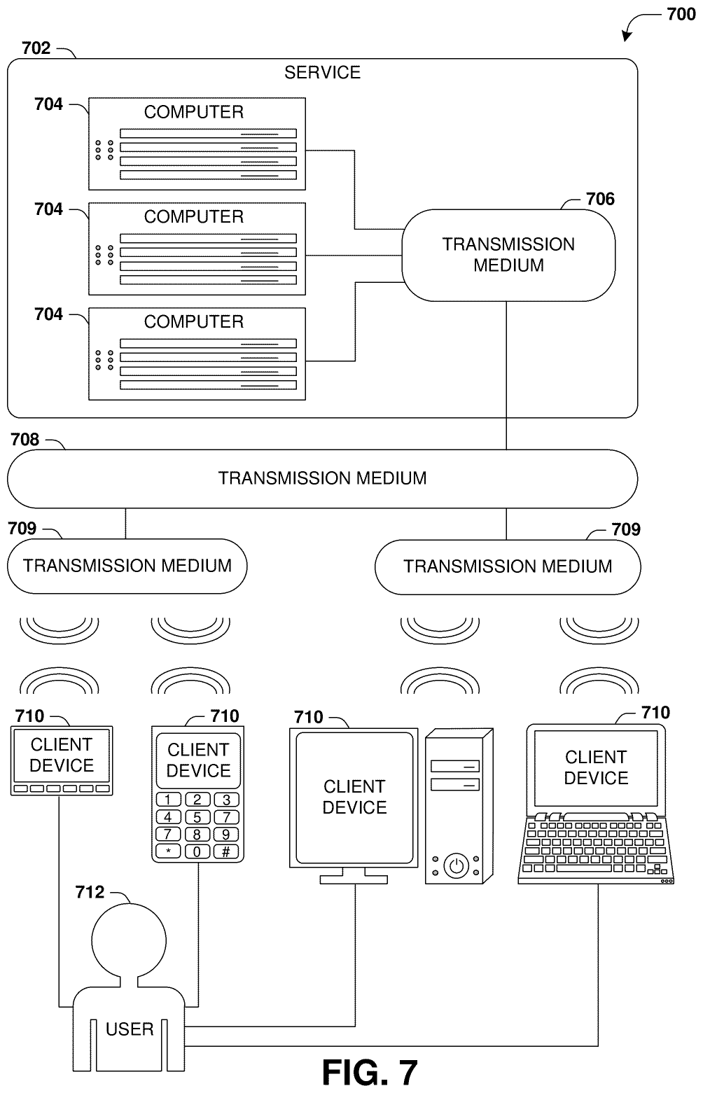

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

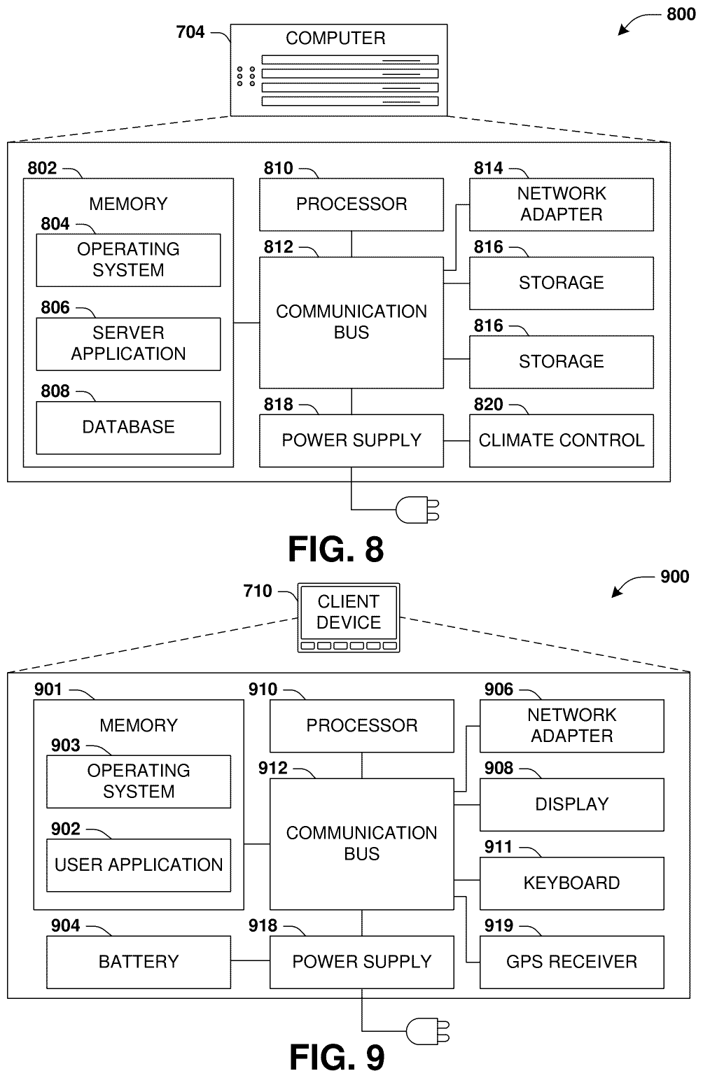

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
receiving, by an application server of a communication network from a dialer app of user equipment, a call initiation request to establish a communication call session between the user equipment and a recipient number;
identifying information associated with the recipient number, wherein the information indicates whether the recipient number is a known suspicious actor or not; and
providing, through the user equipment before establishing the communication call session, the information and an option to proceed or cancel with establishing the communication call session to call the recipient number.

2. The method of claim 1, wherein the providing comprises:
creating, by the application server, a temporary early media path between the user equipment and the application server to establish two-way audio without the application server answering the call; and
playing an audio message with the information utilizing the temporary early media path.

3. The method of claim 1, wherein the providing comprises:
displaying the information through at least one of text or a graphic displayed through an extension in the dialer app.

4. The method of claim 1, comprising:
maintaining, by the application server, an invite transaction until an indication is received from a user to proceed with the call or a timeout has occurred; and
in response to receiving the indication, utilizing the invite transaction for routing to the recipient number.

5. The method of claim 1, wherein the providing comprises:
selecting an amount and type of detail to provide as the information based upon a setting.

6. The method of claim 1, wherein the providing comprises:
in response to detecting a threat level associated with the recipient number, selecting a suggestion for how to proceed with the call; and
including the suggestion within the information provided to a user, wherein the suggestion is provided to the user before the communication call session is established.

7. The method of claim 1, wherein the providing comprises:
in response to receiving a break-in indicator from the dialer app, implementing a user break-in operation to dial the recipient number.

8. The method of claim 1, wherein the providing comprises:
instructing the user equipment to display an interface through which a user can submit a report related to the recipient number; and
in response to receiving the report, updating call information accessible to the application server based upon the report.

9. The method of claim 1, wherein the providing comprises:
in response to detecting that the recipient number is within a contact list, is a number called above a threshold frequency, or is a designated opt-out number, bypassing the application server processing the recipient number.

10. A system, comprising:
one or more processors configured for executing instructions to perform operations comprising:
receiving, by an application server of a communication network from a dialer app of user equipment, a call initiation request to establish a communication call session between the user equipment and a recipient number;
identifying information associated with the recipient number, wherein the information indicates whether the recipient number is a known suspicious actor or not; and
providing, through the user equipment before establishing the communication call session, the information and an option to proceed or cancel with establishing the communication call session to call the recipient number.

11. The system of claim 10, wherein the operations further comprise:
registering a user of the user equipment for called party identification verification;
in response to the user being registered for the called party identification verification, invoking an originating service provider to verify an identity of the recipient number; and
providing the identity to the user.

12. The system of claim 11, wherein the operations further comprise:
providing the identity to the user as part of connecting the dialer app to the recipient number.

13. The system of claim 11, wherein the operations further comprise:
configuring the originating service provider with a feature-capability indicator within a header field in an invite to indicate that the originating service provider has a capability of performing called party identification verification.

14. The system of claim 11, wherein identity information for the recipient number is cryptographically signed with at least one of a user name, a company name, or a service type, wherein the identity information is used by a terminating service provider to verify the identity of the recipient number with the originating service provider.

15. A non-transitory computer-readable medium storing instructions that when executed facilitate performance of operations comprising:
receiving, by an application server of a communication network from a dialer app of user equipment, a call initiation request to establish a communication call session between the user equipment and a recipient number;
identifying information associated with the recipient number, wherein the information indicates whether the recipient number is a known suspicious actor or not; and
providing, through the user equipment before establishing the communication call session, the information and an option to proceed or cancel with establishing the communication call session to call the recipient number.

16. The non-transitory computer-readable medium of claim 15, wherein the operations further comprise:
in response to a user being registered for in-call support, providing a call recording option for calling the recipient number; and
in response to receiving user input for the call recording option, recording the call between the user and the recipient number.

17. The non-transitory computer-readable medium of claim 15, wherein the operations further comprise:
in response to a user being registered for in-call support, providing a live support option for calling the recipient number; and
in response to receiving user input for the live support option, merging a call support user into the call between the user and the recipient number.

18. The non-transitory computer-readable medium of claim 15, wherein the operations further comprise:
in response to a user being registered for in-call support, providing an artificial intelligence support option for calling the recipient number; and
in response to receiving user input for the artificial intelligence support option, providing the user with artificial intelligence support during the call between the user and the recipient number.

19. The non-transitory computer-readable medium of claim 15, wherein the operations further comprise:
in response to a user being registered for in-call support, providing a feedback reporting option for calling the recipient number; and
in response to receiving user input for the feedback reporting option, providing the user with a feedback reporting user interface through which to report feedback regarding the call.

20. The non-transitory computer-readable medium of claim 19, wherein the operations further comprise:
in response to receiving a report through the feedback reporting option, updating call information accessible to the application server based upon the report.
